(19) United States
(12) Patent Application Publication
(10) Pub. No.: US 2012/0217254 A1
(43) Pub. Date: Aug. 30, 2012

(54) Refrigerator

(75) Inventors: A Ra Cho, Suwon-si (KR); Seong Ho Cho, Yongi-si (KR); Hoon Kim, Suwon-si (KR); Min Su Lee, Suwon-si (KR); Eun Kyung Hong, Anyang-si (KR)

(73) Assignee: SAMSUNG ELECTRICS CO., LTD., Suwon-si (KR)

(21) Appl. No.: 13/137,613

(22) Filed: Aug. 30, 2011

(30) Foreign Application Priority Data
Feb. 25, 2011 (KR) 10-2011-0017044

(51) Int. Cl. F25D 11/00

(52) U.S. Cl. 220/592.02

(57) ABSTRACT

A refrigerator which provides a grocery manager interface through a display so that storage locations and periods and best before periods of foods stored in the refrigerator are easily judged, thereby effectively managing the stored foods. The refrigerator includes storage chambers to store foods, a display unit having a touch screen function, and a grocery manage interface to display food items corresponding to the foods stored in the storage chambers and to manage the displayed food items using a drag and drop method.

### CROSS-REFERENCE TO RELATED APPLICATIONS

This application claims the benefit of Korean Patent Application No. 10-2011-0017044, filed on Feb. 25, 2011 in the Korean Intellectual Property Office, the disclosure of which is incorporated herein by reference.

### BACKGROUND

1. Field

Embodiments of the present disclosure relate to a refrigerator with a display.

2. Description of the Related Art

In general, refrigerators serve to store foods at a low temperature so as to keep the foods in a fresh state for a long time. However, even if food is stored at a low temperature, the time for which freshness of the food is maintained is just lengthened but freshness of the food can not be extended indefinitely. Thus, it is desired that consumption of food is carried out before freshness of the food has been lost.

In a conventional refrigerator, since storage periods of foods are different and it is not easy to check positions in storage chambers where the foods are stored, it is not easy to judge the storage periods of the foods. Therefore, consumption of food is not achieved during a period while freshness of the food is maintained and thus the food may be wasted.

### SUMMARY

Therefore, it is an aspect of the present disclosure to provide a refrigerator which provides a grocery manager interface through a display so that storage locations and periods and best before periods of foods stored in the refrigerator are easily judged, thereby effectively managing the stored foods.

Additional aspects of the disclosure will be set forth in part in the description which follows and, in part, will be apparent from the description, or may be learned by practice of the disclosure.

In accordance with one aspect of the present disclosure, a refrigerator includes storage chambers to store foods, and a touch screen-type display unit to display a storage chamber user interface (UI) representing the internal structures of the storage chambers and a food item list representing food items and to move the food items from the food item list to the storage chamber UI using a drag and drop method so as to display food storage states of the storage chambers on the storage chamber UI.

The refrigerator may further include an information display area to display information of the stored foods, and the food item list to display a list of the stored foods.

The storage chamber UI may be divided into a freezing chamber door area, a freezing chamber shelf area, a refrigerating chamber shelf area and a refrigerating chamber door area.

Each of the freezing chamber door area, the freezing chamber shelf area, the refrigerating chamber shelf area and the refrigerating chamber door area may be divided into an upper sub-area and a lower sub-area.

The food item list may include a page information display area to display the greater number of food items than the number of current displayed food items.

The refrigerator may further include an adding button to add food items to the storage chamber UI, and, when a food item displayed in the food item list is added through the adding button, the food item may be moved using the drag and drop method.

The refrigerator may further include a trash bin icon to delete food items in the storage chamber UI, and, when a food item displayed in the storage chamber UI is deleted, the food item may be moved to the trash bin icon using the drag and drop method.

The food item list may display food items corresponding to the foods stored in the storage chambers by applying priority to foods having shorter remaining best before periods from among the foods stored in the storage chambers.

The food item list may display the food items in order of food items corresponding to foods, best before periods of which have expired, food items corresponding to foods, best before periods of which expires within a designated period, and food items corresponding to foods, best before periods of which remain for more than the designated period.

The food item list may display food items corresponding to foods, best before periods of which have expired, and food items corresponding to foods, best before periods of which expires within a designated period, from among the foods stored in the storage chambers.

Icons of the food items may be formed in shapes of corresponding foods so that actual foods may be judged through the icons.

The icons of the food items may be provided with names of corresponding foods.

When a food item located in the storage chamber UI is selected, storage information of corresponding food may be displayed in the information display area.

The information of the corresponding food may include at least one of a stored date, a recommended best before period and days past the recommended best before period.

In accordance with another aspect of the present disclosure, a refrigerator including storage chambers to store foods, and a touch screen-type display unit to display food items corresponding to the foods stored in the storage chambers in shapes of icons and to add, delete and move the icons of the food items using a drag and drop method so as to display food storage states of the storage chambers.

The refrigerator may further include a storage chamber user interface (UI) to represent the internal structures of the storage chambers and to display kinds and storage locations of the foods stored in the storage chambers through shapes and locations of the icons of the food items, an information display area to display information regarding the foods, and a food item list to display a list of the foods

The storage chamber UI may be divided into a freezing chamber door area, a freezing chamber shelf area, a refrigerating chamber shelf area and a refrigerating chamber door area.

Each of the freezing chamber door area, the freezing chamber shelf area, the refrigerating chamber shelf area and the refrigerating chamber door area may be divided into an upper sub-area and a lower sub-area.

In accordance with yet another aspect of the present disclosure, a refrigerator includes storage chambers to store foods, and a display unit to display a storage chamber user interface (UI) representing the internal structures of the storage chambers, an information display area to display information of the stored foods and a food item list to display food items, and to move the food items from the food item list to the storage chamber UI using a drag and drop method so as to display food storage states of the storage chambers on the storage chamber UI.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating the external appearance of a refrigerator in accordance with one embodiment of the present disclosure;

FIG. 2 is a block diagram of a control system of the refrigerator of FIG. 1;

FIG. 3 is a view illustrating the configuration of a screen of a display of the refrigerator of FIG. 1;

FIG. 4 is a view illustrating a screen of a grocery manger interface;

FIG. 5 is a view illustrating a storage chamber UI of the grocery manger interface;

FIG. 6 is a more detailed view illustrating the storage chamber UI of FIG. 5;

FIG. 7 is a view illustrating a food item list of the grocery manager interface;

FIG. 8, parts (A)-(D), are views illustrating an information display area of the grocery manager interface;

FIG. 9, parts (A)-(D), are views illustrating setting of a desired option by a user in a method of displaying food items through a setting button;

FIGS. 10, parts (A)-(D), 11, parts (A)-(D), and 12, parts (A)-(D), are views illustrating methods of adding food items through an adding button;

FIG. 13, parts (A)-(D), are views illustrating a method of deleting food items through a deleting button;

FIG. 14 is a view illustrating the configuration of an initial screen of the display of FIG. 3 in a tree structure;

FIG. 15 is a view illustrating the detailed configuration of the grocery manager from among the configuration of the initial screen of FIG. 14; and

FIG. 16 is a view illustrating the detailed configuration of a menu from among the configuration of the initial screen of FIG. 14.

### DETAILED DESCRIPTION

Reference will now be made in detail to the embodiments of the present disclosure, examples of which are illustrated in the accompanying drawings, wherein like reference numerals refer to like elements throughout.

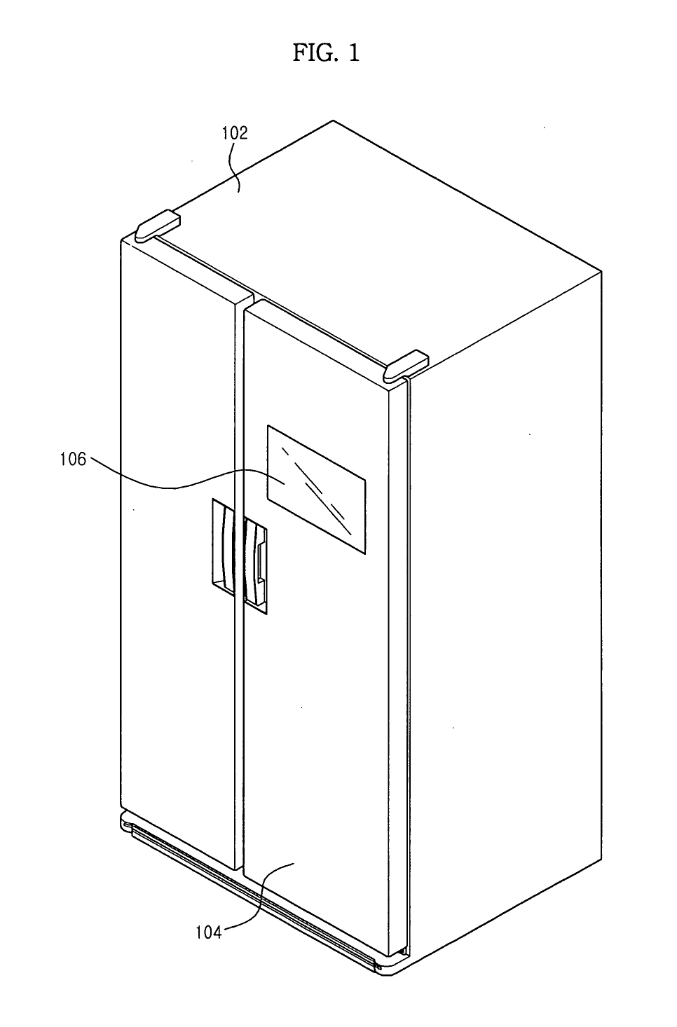

FIG. 1 is a perspective view illustrating the external appearance of a refrigerator in accordance with one embodiment of the present disclosure. As shown in FIG. 1, doors 104 to open and close storage chambers within a main body 102 of the refrigerator are installed in front of the main body 102 of the refrigerator. In the refrigerator of FIG. 1, two doors 104 are disposed at left and right sides of the refrigerator. However, the two doors 104 may be disposed at upper and lower portions of the refrigerator according to positions of the storage chambers, i.e., a refrigerating chamber and a freezing chamber. A display 106 is installed on the right door 104. The display 106 serves to allow a user to easily judge and manage a state of the refrigerator (particularly, states of the stored food items). The display 106 is implemented as a liquid crystal display (LCD), and a touch screen to directly touch the display 106 to manipulate the display 106 is connected to the display 106. The display 106 may be implemented as other types, and the touch screen may be implemented as a capacitive or resistive type or other types. Further, besides the touch screen method, other input methods may be used.

“Food” or “grocery” stated in the embodiment of the present disclosure represents all articles stored in the refrigerator.

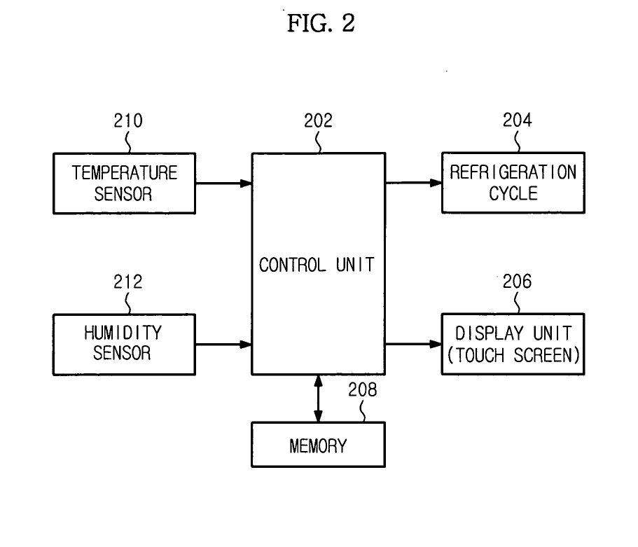

FIG. 2 is a block diagram of a control system of the refrigerator of FIG. 1. As shown in FIG. 2, a control unit 202 to control the overall operation of the refrigerator has a day counting function through a timer installed therein, and judges whether or not storage expiring days or best before periods of stored foods have come through the day counting function. The control unit 202 may use an external timer instead of the timer installed in the control unit 202, as needed. The display 106 is communicably connected to the output side of the control unit 202. When a user touches the surface of the touch screen-type display 106, the display 106 recognizes this touch as one input. The display 106 displays a grocery manager interface in accordance with the embodiment of the present disclosure to allow the user to use the grocery manger interface. Further, a memory 208 is communicably connected to the control unit 202. The memory 208 stores software or data necessary for the control unit 202 to control the overall operation of the refrigerator. The control unit 202 displays information, such as storage locations and periods and best before periods of foods stored in the refrigerator, receives a user input to manage the information through the touch screen and processes the received input, thereby effectively managing the foods stored in the refrigerator. Further, the control unit 202 controls a refrigeration cycle 204 to achieve the operation of the refrigerator. The refrigeration cycle 204 basically includes a compressor, a condenser, an expansion valve and an evaporator, which are connected through refrigerant paths, and may further include various additional refrigerant paths and valves to improve cooling efficiency of the refrigerator. A temperature sensor 210 and a humidity sensor 212 are communicably connected to the input side of the control unit 202. The temperature sensor 210 and the humidity sensor 212 detect temperature and humidity values of the storage chambers and provide the detected temperature and humidity values to the control unit 202, and the control unit 202 controls the refrigeration cycle 204 based on the detected temperature and humidity values so that the temperatures and humidity in the storage chambers maintain target temperatures and target humidity.

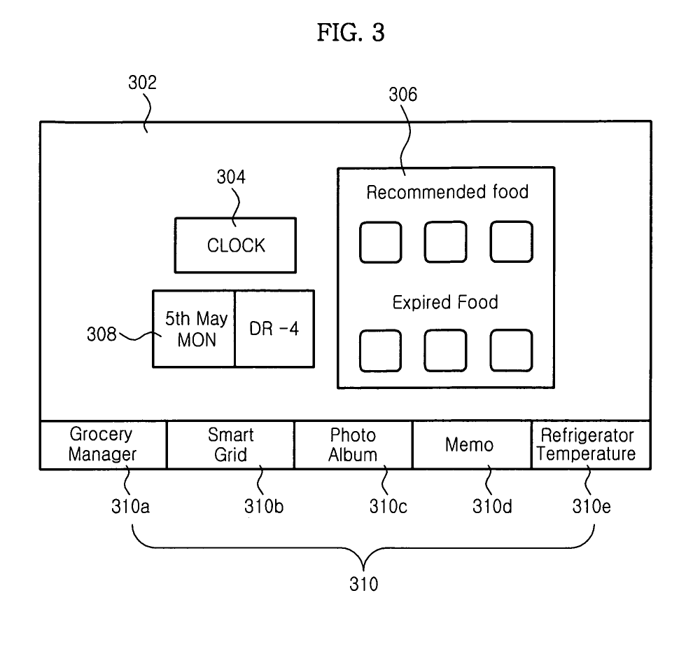

FIG. 3 is a view illustrating the configuration of a screen of the display of the refrigerator of FIG. 1. As shown in FIG. 3, the screen of the display 106 is divided into a background 302, a clock 304, a grocery manager 306, a diary 308, and a menu 310.

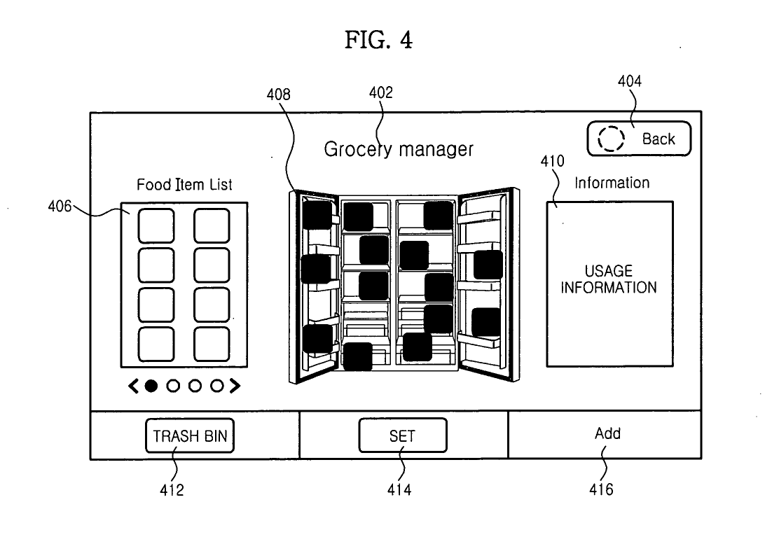

The background 302 shows a predetermined image. For example, the predetermined image may be an image according to season or an image according to time zone (day and night, etc.). The clock 304 indicates current time. For example, current time may be indicated in a 24 hour display method or a 12 hour display method. The grocery manager 306 displays recommended foods and foods, validity periods of which expire, i.e., expired foods. That is, the grocery manager 306 displays 3 recommended food items in a 3×1 arrangement in order of more distant stored date, and displays 3 expired food items in a 3×1 arrangement in order of more distant stored date. If there are no recommended food and no expired food, the grocery manager 306 displays images of current food items in order of more distant stored date. Representative food items selected in respective various food categories are set as the recommended food items, and if current stored food items include these recommended food items, the recommended food items are displayed so as to allow the user to refer to them. The diary 308 displays a date at the left side thereof and a DR level at the right side thereof. The DR level represents an energy cost of current supplied power, and is expressed in a figure, such 1, 2, 3 or 4. Further, the DR level may be expressed in a colored circle. For example, level 1 is expressed in green, level 2 is expressed in yellow, level 3 is expressed in orange, and level 4 is expressed in red. The menu 310 includes a grocery manager item 310a, a smart grid item 310b, a photo album item 310c, a memo item 310d, and a refrigerator temperature item 310e. The clock 304 and the diary 308 are configured not to react even if the user selects (touches) the clock 304 and the diary 308. The grocery manager 306 displays a grocery manager interface (with reference to FIG. 4) if the user selects (touches) the grocery manager 306. The menu 310 displays functions of screens of the respective items if the user selects (touches) the respective items of the menu 310.

FIG. 4 is a view illustrating a screen of the grocery manger interface. As shown in FIG. 4, the grocery manager interface includes a title area 402, a back button 404, a food item list 406, a storage chamber user interface (UI) 408, an information display area 410, a trash bin 412, a setting button 414, and an adding button 416. The title area 402 displays the name of a current selected screen (i.e., ‘grocery manager’). The back button 404 returns the current displaying screen to the previous screen. The storage chamber UI 408 displays images and storage locations of current stored food items. The information display area 410 displays information regarding four states, as follows. That is, the information display area 410, when the grocery manager interface is executed, displays the usage information relating to the grocery manager interface, when a food item is selected from the food item list 406, displays corresponding food information, when the storage chamber UI 408 is selected, displays a food item list stored at a corresponding storage location, and when there is no food stored in a storage area within the refrigerator, displays a notifying message to notify this fact. The trash bin 412 stores deleted food items, and shows the stored food items when the trash bin 412 is selected. The setting button 414 is used for user desired setting in display of recommended food items, and the adding button 416 is used to add food items.

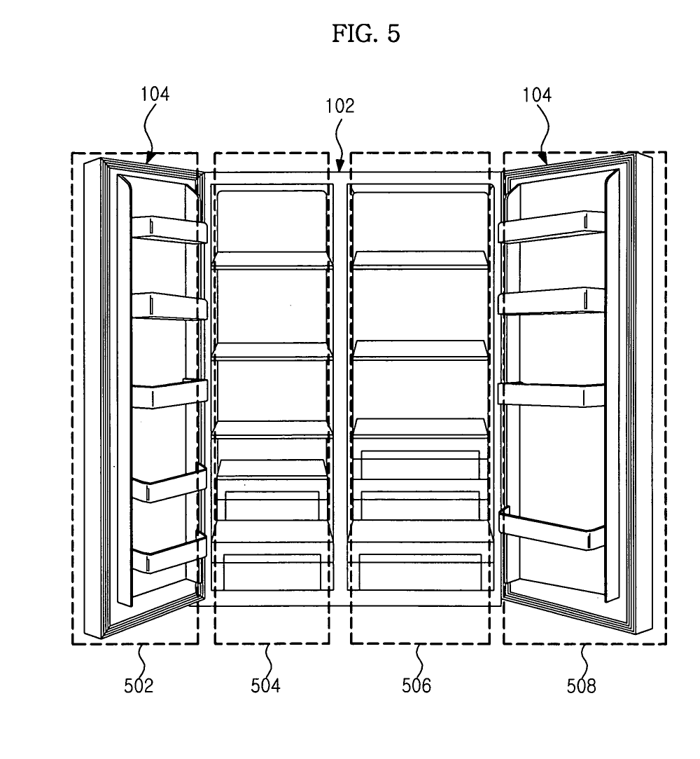

FIG. 5 is a view illustrating the storage chamber UI of the grocery manger interface. In the refrigerator in accordance with the embodiment of the present disclosure, a plurality of storage areas divided from each other is provided within the main body 102 and at the inner portions of the doors 104, and the display 106 displays structures of the storage areas so as to display locations at which food items are stored in each of the respective storage areas. The storage chamber UI 408, as shown in FIG. 5, is divided into a freezing chamber door area 502, a freezing chamber shelf area 504, a refrigerating chamber shelf area 506, and a refrigerating chamber door area 508.

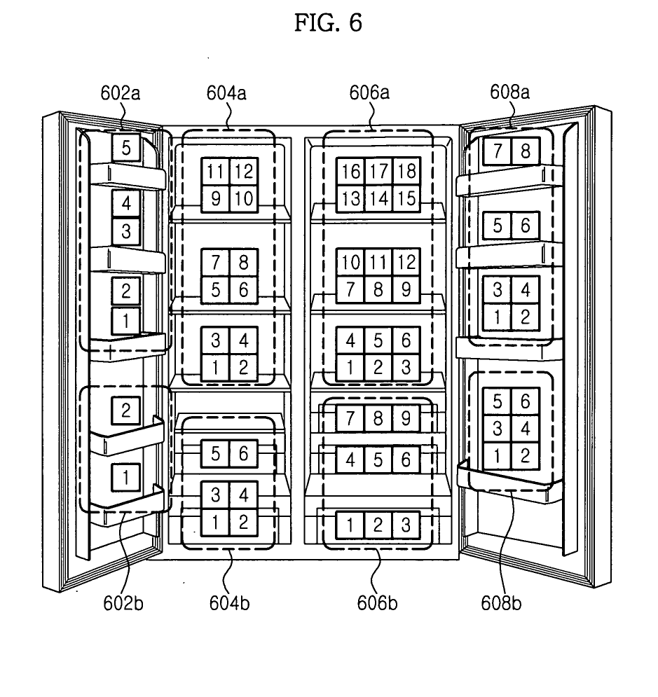

FIG. 6 is a more detailed view illustrating the storage chamber UI of FIG. 5. As shown in FIG. 6, the freezing chamber door area 502, the freezing chamber shelf area 504, the refrigerating chamber shelf area 506, and the refrigerating chamber door area 508 illustrated in FIG. 5 are further divided into upper sub-areas 602a, 604a, 606a and 608a and lower sub-areas 602b, 604b, 606b and 608b, respectively. Food items stored in each of the upper sub-areas 602a, 604a, 606a and 608a and the lower sub-areas 602b, 604b, 606b and 608b are arranged from the left to the right and then from the lower part to the upper part in order of more distant stored date. Further, only food item images up to the maximum food item display number of each of the upper sub-areas 602a, 604a, 606a and 608a and the lower sub-areas 602b, 604b, 606b and 608b are displayed. The maximum food item display number of the upper sub-area 602a of the freezing chamber door area 502 is 5 and the maximum food item display number of the lower sub-area 602b of the freezing chamber door area 502 is 2. The maximum food item display number of the upper sub-area 604a of the freezing chamber shelf area 504 is 12 and the maximum food item display number of the lower sub-area 604b of the freezing chamber shelf area 504 is 6. The maximum food item display number of the upper sub-area 606a of the refrigerating chamber shelf area 506 is 18 and the maximum food item display number of the lower sub-area 606b of the refrigerating chamber shelf area 506 is 9. The maximum food item display number of the upper sub-area 608a of the refrigerating chamber door area 508 is 8 and the maximum food item display number of the lower sub-area 608b of the refrigerating chamber door area 508 is 6.

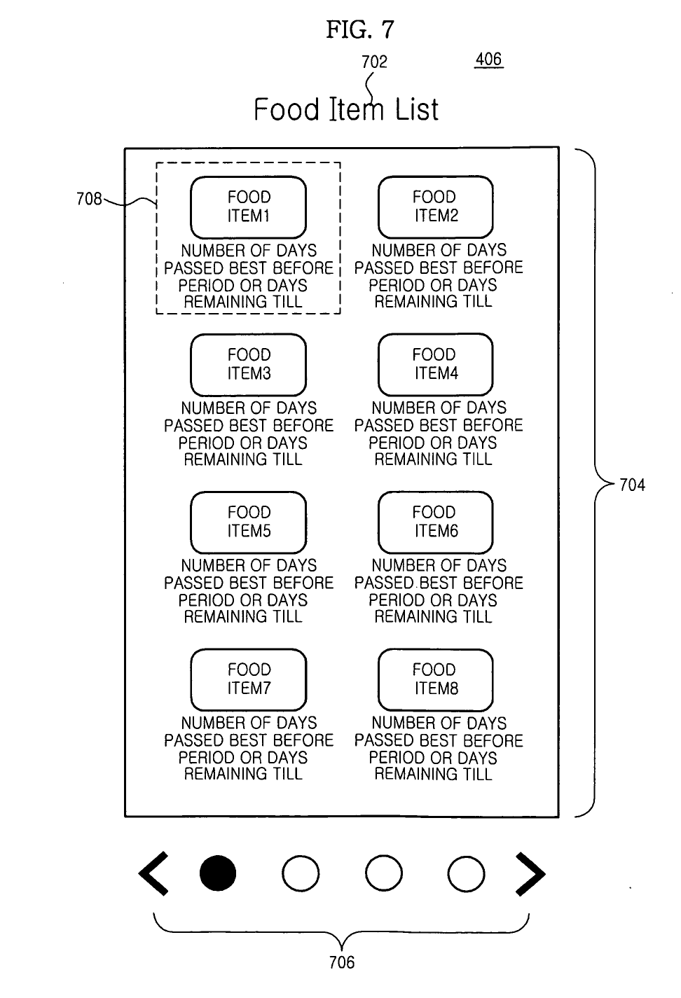

FIG. 7 is a view illustrating the food item list of the grocery manager interface. As shown in FIG. 7, the food item list 406 includes a title 702, a food item list display area 704 and a page information display area 706.

In the food item list display area 704, 8 food items 708 are displayed in a 2×4 arrangement in order of more distant stored date. If no food item is stored, a corresponding message, i.e., a message of “There is no food item. Select [Add] button and add the food item(s)” is given. The food items 708 displayed in the food item list display area 704 have names of the food items 708 and information regarding the number of days past best before periods or the number of remaining days to reach the best before periods, or information regarding stored dates. Further, the food item 708 is expressed in red if the best before period of the food item 708 has expired, expressed in yellow if today is the last day of the best before period of the food item 708, and expressed in blue if the best before period of the food item 708 remains. If the best before period of the food item 708 has expired or remains, the number of days past the best before period or remaining days to reach the best before period is displayed up to 999 to the maximum. If the number of days past the best before period or remaining days to reach the best before period exceeds 999, the number of days is displayed only up to 999. When one food item 708 in the food item list display area 704 is selected, storage information of the corresponding food item 708 is displayed in the right information display area 410 (with reference to FIG. 4), and the corresponding food item 708 and the inner area of the refrigerator in which the corresponding food item 708 is stored is lighted. A user may move the food item 708 to a desired position using a drag and drop method. The drag and drop method is an action of grabbing a specific content in a screen and dragging the content from a position A to another position B using a mouse. For example, when one food item 708 displayed in the food item list display area 704 is dragged and moved to the trash bin 412, the corresponding food item 708 is deleted from the food item list display area 704. The positions of the food items 708 may be changed in such a manner. If the position of one food item 708 deviates from the food item list display area 704 during dragging of the food item 708, the color of the food item 708 is changed into gray to notify that the food item 708 is deactivated.

The page information display area 706 serves to display the greater number of food items than the number of current displayed food items 708. In the page information display area 706, the total number of circle buttons represents the total number of pages, and the position of a circle button, the inside of which is filled, from among the circle buttons represents a current page. For example, “∘∘” represents display of the first page from among three pages. Further, “∘∘∘∘” represents display of the third page from among five pages. The maximum number of circle buttons which are simultaneously displayed is 5, and only if the total number of pages is more than 2, the total number of the pages is represented by circle buttons. If the total number of pages exceeds 5, the pages are represented by a previous button <, a previous page number, a next button >, and a next page number. For example, “5<∘∘∘>11” represents display of the sixth page from among eleven pages. The previous button < enables the current page to be moved to the previous page (but, enables the first page to be moved to the last page). The next button > enables the current page to be move to the next page (but, enable the last page to be moved to the first page). If a deactivated circle button is selected, the current page is moved to a corresponding page.

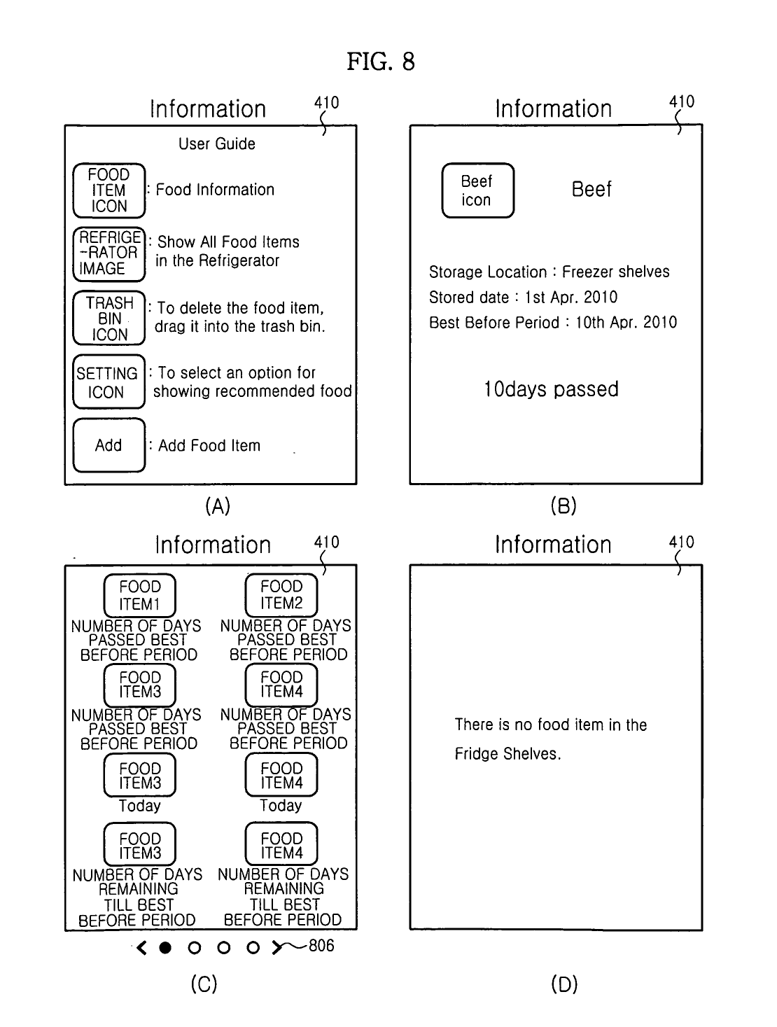

FIG. 8, parts (A) to (D), are views illustrating the information display area of the grocery manager interface. FIG. 8, part (A) shows an initial state of the information display area 410 displaying the usage information of the grocery manager interface. That is, a user guide of the grocery manger interface and description of icons or images are displayed. FIG. 8, part (B), shows a state of the information display area 410, when a food item is selected, displaying information of the selected food item. The displayed information includes a storage location, a stored date, a best before period, and the number of days past the best before period or remaining days to reach the best before period. If the number of days past the best before period or remaining days to reach the best before period exceeds 999, the number of days is displayed up to 999 to the maximum. FIG. 8, part (C), shows a state of the information display area 410 in which, when one storage area of the storage chamber UI 408 is selected, a food item list in the corresponding storage area is displayed. The displayed food item list includes respective food item buttons and information regarding the number of days past best before periods of food items and remaining days to reach the best before periods of the food items. For example, the food item list includes n food items displayed in a 2×4 arrangement in order of food items, best before periods of which have expired, →food items, best before periods of which expire today→food items, best before periods of which remain→food items, stored dates of which are more distant. From among the food item buttons, buttons of food items, best before periods of which have expired, are provided with the red edge and are displayed in order of earlier best before period. Buttons of food items, best before periods of which expire today, are provided with the yellow edge and are displayed in order of more distant stored date. Buttons of food items, best before periods of which remain, are provided with the green edge and are displayed in order of smaller number of remaining days. Further, buttons of food items representing stored dates are provided with the green edge and displays the stored dates. If the number of days past the best before periods or remaining days to reach the best before periods exceeds 999, the number of days is displayed up to 999 to the maximum. A page information display area 806 of FIG. 8, part (C), is operated in the same manner as the page information display area 706 of FIG. 7. FIG. 8, part (D), shows a state of the information display area 410 when there is no food item stored in the corresponding storage area of the storage chamber UI 408, displaying a message of “There is no food item in corresponding refrigerator storage area”.

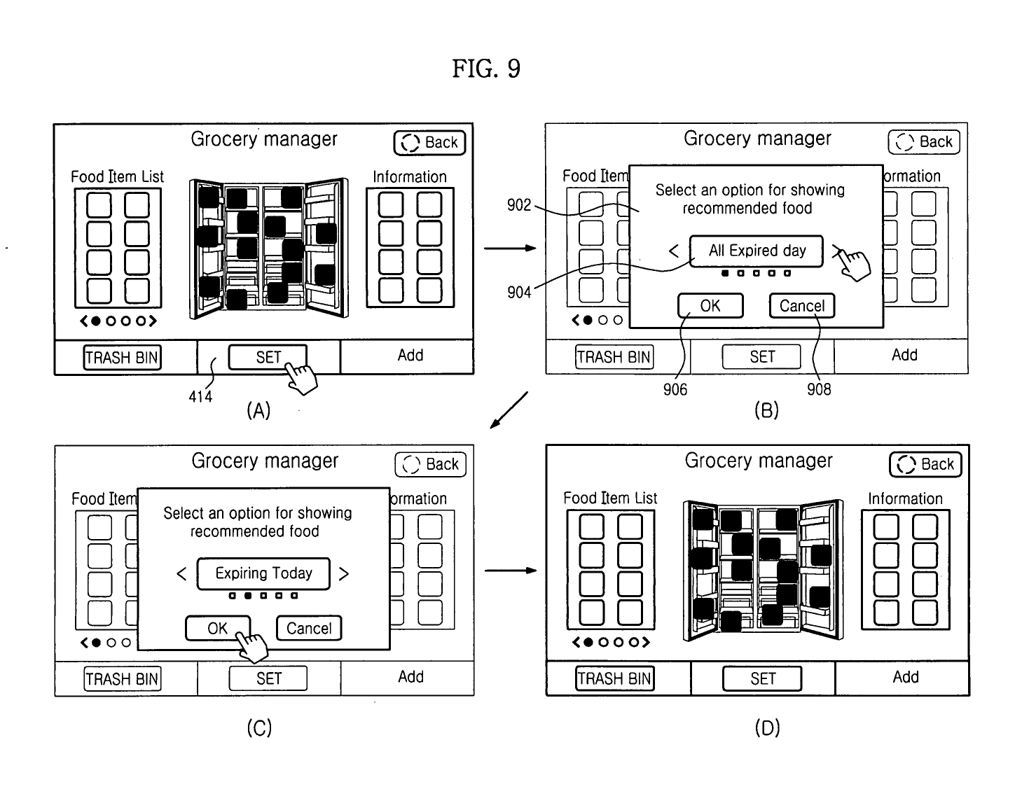

FIG. 9, parts (A) to (D), are views illustrating setting of a desired option by a user in a method of displaying food items through the setting button. When the setting button 414 is selected, as shown in FIG. 9, part (A), a pop-up window 902 is displayed, as shown in FIG. 9, part (B).

A notifying message of “Select an option for showing recommended food” is displayed at the upper end of the pop-up window 902, and a recommended day setting item 904 is displayed under the notifying message. The recommended day setting item 904 includes 5 values, as follows. The basic value is “All Expired day”, and movement between the respective values is carried out using moving buttons “<” and “>”.

All Expired day: displays food items, best before periods of which have expired, in order of earlier best before period.

Expiring Today: displays food items, best before periods of which expire today, in order of more distant stored date.

Expiring in 1 Day: displays food items, best before periods of which expire today, and food items, best before periods of which expire 1 day after, in order.

Expiring in 2 Days: displays food items, best before periods of which expire today, food items, best before periods of which expire 1 day after, and food items, best before periods of which expire 2 days after, in order.

Expiring in 3 Days: displays food items, best before periods of which expire today, food items, best before periods of which expire 1 day after, food items, best before periods of which expire 2 days after, and food items, best before periods of which expire 3 days after, in order.

As described above, Expiring in ‘n’ Days may mean display of food items, best before periods of which expire today, food items, best before periods of which expire ‘n−(n−1)’ days after, food items, best before periods of which expire ‘n−(n−2)’ days after 2 days after, . . . and food items, best before periods of which expire ‘n’ days after, in order.

As shown in FIG. 9, parts (C) and (D), when an OK button 906 is selected, the current value of the pop-up window 902 is stored and the pop-up window 902 is closed. When a cancel button 908 is selected, the values selected until now are not applied and the pop-up window 902 is closed.

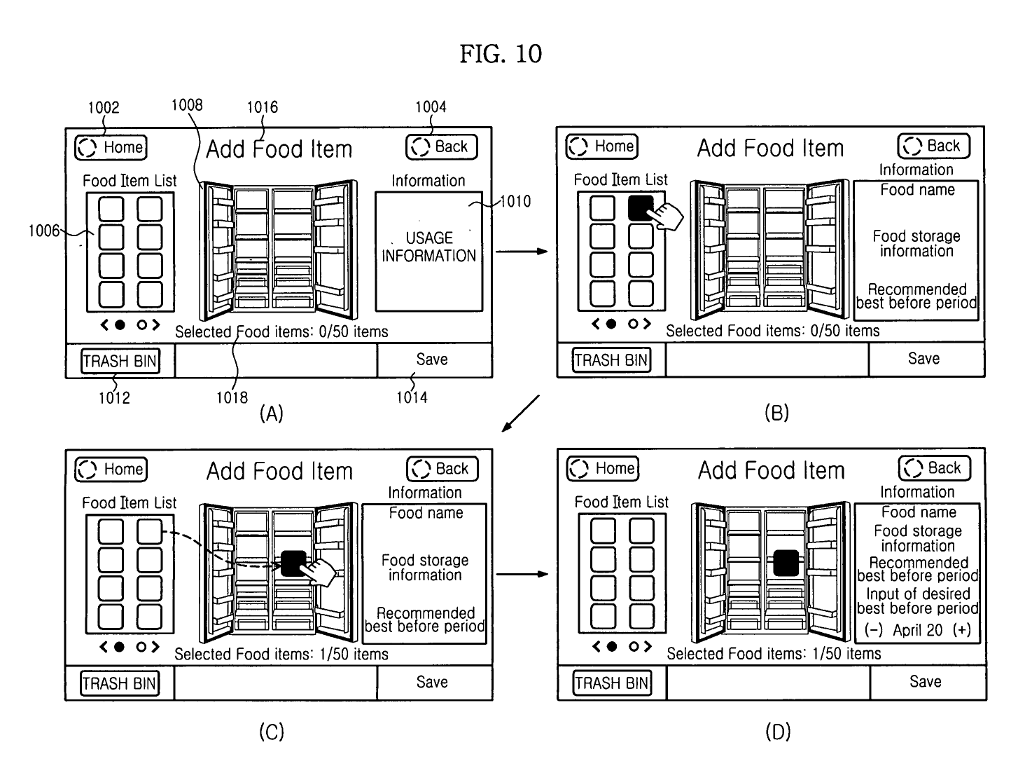

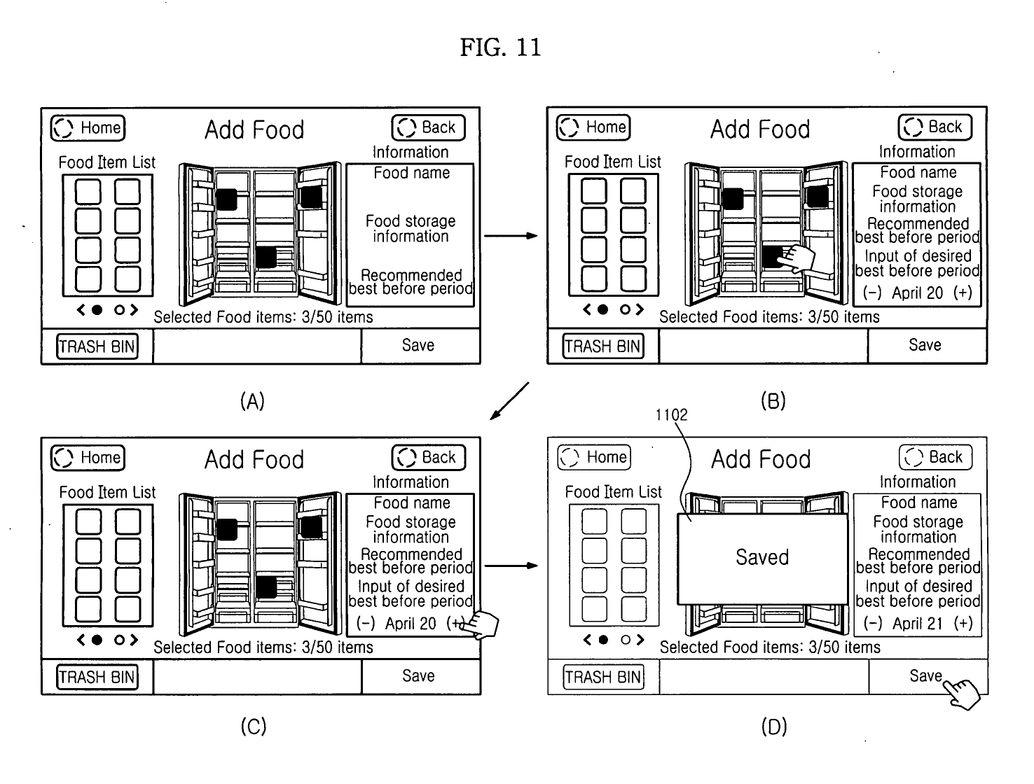

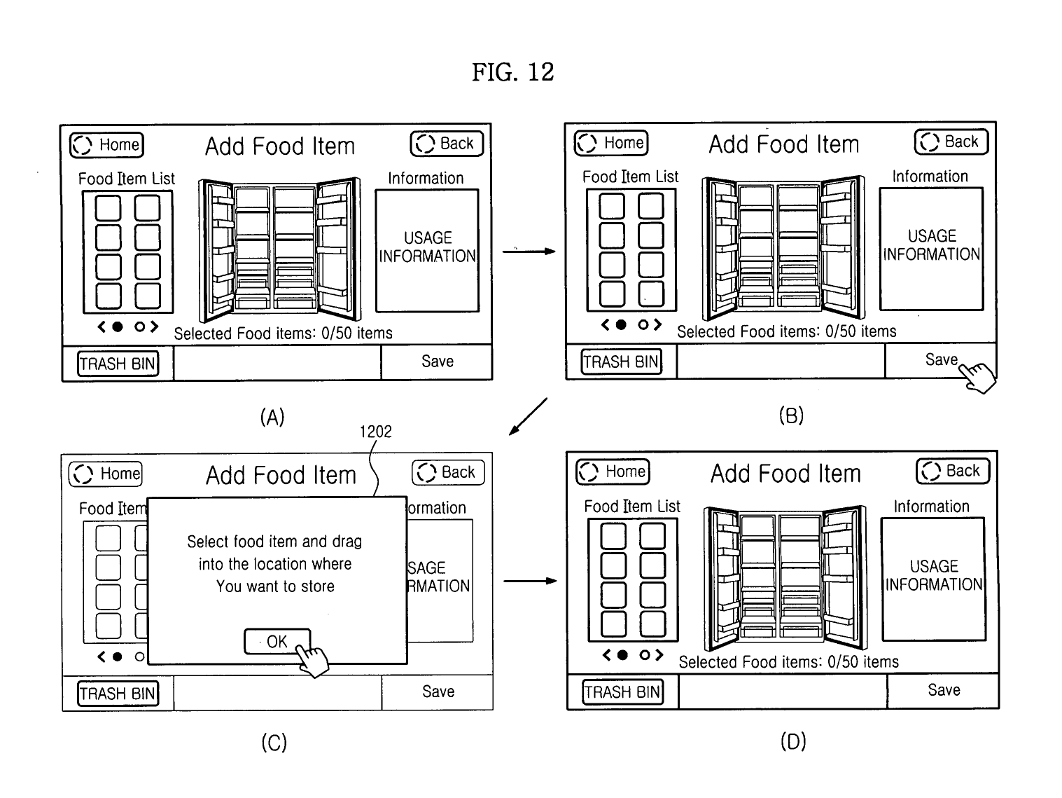

FIGS. 10, parts (A)-(D), 11, parts (A)-(D), and 12, parts (A)-(D), are views illustrating methods of adding food items through the adding button. When the adding button 416 is selected on the screen of FIG. 4, a food item adding screen is displayed, as shown in FIG. 10, part (A). On the food item adding screen, a home button 1002, a back button 1004, a food item list 1006, a storage chamber UI 1008, an information display area 1010, a trash bin 1012, a save button 1014, a title 1016, and a selected food number area 1018.

When the home button 1002 is selected, the initial screen shown in FIG. 3 is displayed. When the back button 1004 is selected, the previous screen is displayed. The food item list 1006 shows 8 food items displayed in a 2×4 arrangement. When one food item is selected from the food item list 1006 is selected, information of the corresponding food item is displayed in the right information display area 1010. Further, a food item desired to be stored is selected from the food item list 1006 and then a desired storage area of the storage chamber UI 1008 is selected, the selected food item is located in the corresponding storage area of the storage chamber UI 1008. Here, icons of the food items shown in the storage chamber UI 1008 are formed in the shapes of the corresponding food items or are provided with the names of the corresponding food items so that actual foods may be judged through the icons. The storage chamber UI 1008 is the same as that of FIG. 5. The information display area 1010 shows information based on three states. The information display area 1010 shows usage information of a food adding mode at the initial stage of the food adding mode, shows, when a food item is selected, food item information, and shows, when a food item in the storage chamber UI 1008 is selected, information of the selected food item. That is, the information display area 1010 shows a recommended best before period, matters that require attention during storage and an item to input a best before period desired by a user. The information of the selected food item includes a best before period, and the best before period may be randomly adjusted by the user. The trash bin 1012 is the same as that of FIG. 4. When the save button 1014 is selected, a save notifying pop-up window 1102 to notify save of information is displayed and then the information input until now is stored (with reference to FIG. 11, parts (A), to (D)). When the save notifying pop-up window 1102 disappears, the initial screen of the grocery manager (with reference to FIG. 3) is shown. The selected food number area 1018 shows the number of food items selected by the user and dragged to the storage chamber UI 1008, and the number of the food items shown in the selected food number area 1018 is in the range of 0˜50. Further, when no food item is selected from the food item list 1006 but the save button 1014 is selected, as shown in FIG. 12, part (B), a pop-up window 1202 giving a message of selecting a food item and dragging the food item into a desired area in the storage chamber UI 1008 is displayed, and when the user selects a food item and drags and drops the food item into the storage chamber UI 1008, information representing that the corresponding food is stored in the corresponding storage area is displayed.

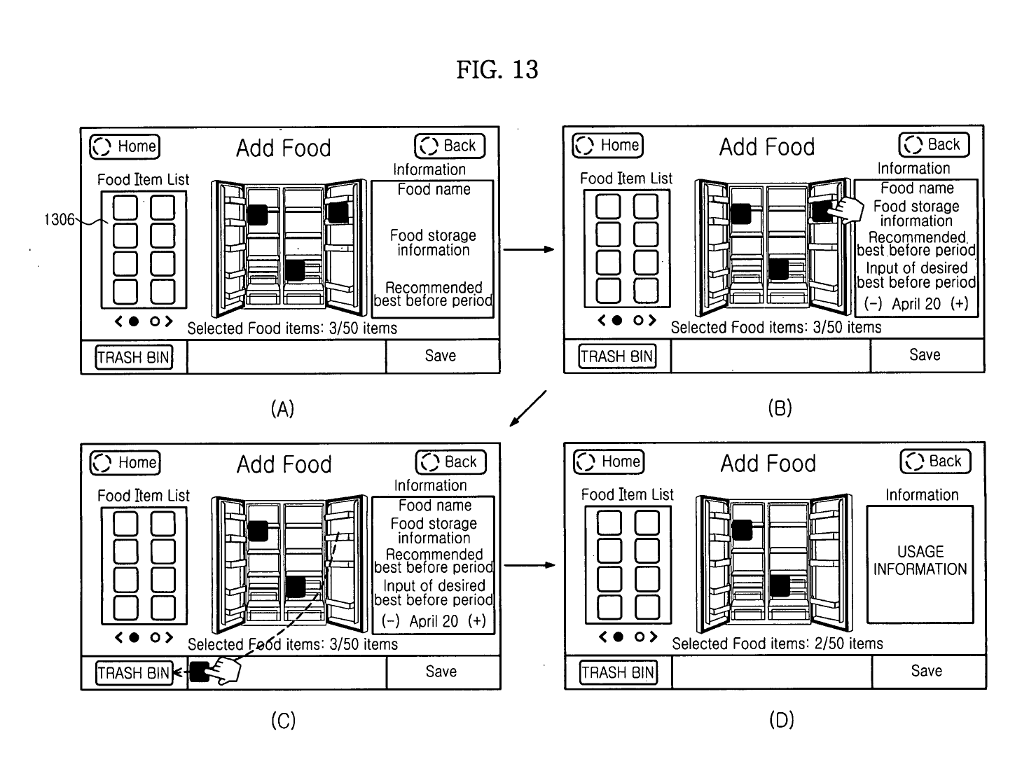

FIG. 13, parts (A) to (D), are views illustrating a method of deleting food items through the deleting button. Deletion of a food item is carried out on the food item adding screen. When a storage area at which a food item desired to be deleted from among food items shown in the storage chamber UI 1008 is selected, food items stored in the corresponding storage area are displayed in a food item list 1306, and when the food item desired to be deleted from among the food items displayed in the food item list 1306 is moved to the trash bin 1012 using the drag and drop method, the corresponding food item is deleted from the storage chamber UI 1008.

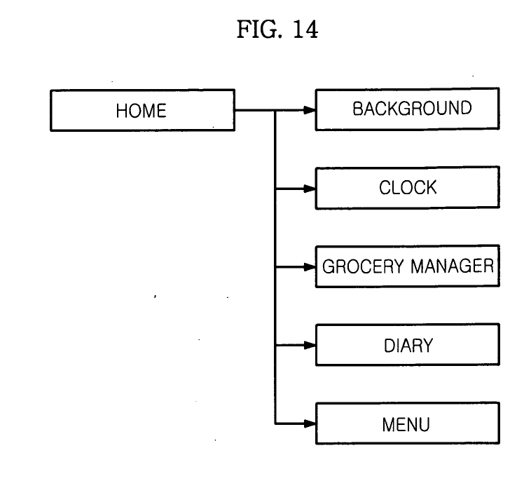

FIG. 14 is a view illustrating the configuration of the initial screen of the display of FIG. 3 in a tree structure. As shown in FIG. 14, the initial screen (home) includes a background, a clock, a grocery manager, a diary, and a menu.

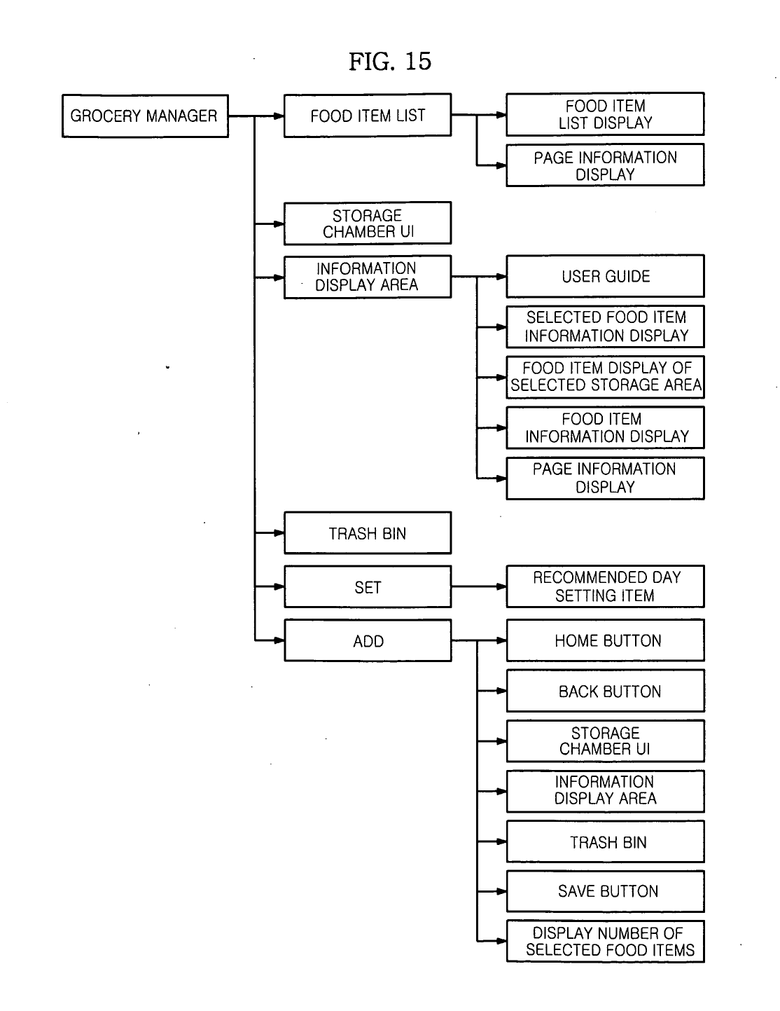

FIG. 15 is a view illustrating the detailed configuration of the grocery manager from among the configuration of the initial screen of FIG. 14. As shown in FIG. 15, the grocery manager includes a food item list, a storage chamber UI, an information display area, a trash bin, a setting area, and an addition area.

The food item list includes a food item list display area and a page information display area.

The information display area includes a user guide (initial screen), a selected food item information display, a food item display of a selected storage area, a food item information display, and a page information display.

The setting area includes a recommended day setting item as a sub-menu.

The addition area includes a home button, a back button, a storage chamber UI, an information display area, a trash bin, a save button, a selected food item number display, etc., as a sub-menu.

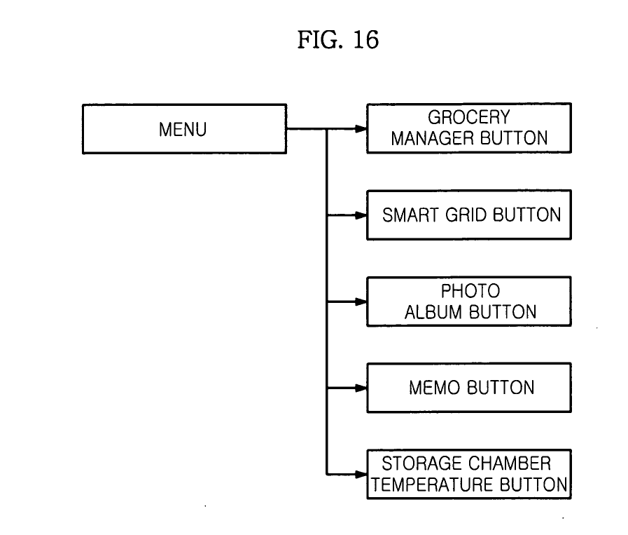

FIG. 16 is a view illustrating the detailed configuration of the menu from among the configuration of the initial screen of FIG. 14. As shown in FIG. 16, the menu includes a grocery manager button, a smart grid button, a photo album button, a memo button, and a storage chamber temperature button. The initial screen is moved to the corresponding item through selection of one of these buttons, and thus a desired operation is performed.

As is apparent from the above description, a refrigerator in accordance with one embodiment of the present disclosure provides a grocery manager interface through a display so that storage locations and periods and best before periods of foods stored in the refrigerator are easily judged, thereby effectively managing the stored foods.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A refrigerator comprising:
storage chambers to store foods; and
a touch screen-type display unit to display a storage chamber user interface (UI) representing the internal structures of the storage chambers and a food item list representing food items and to move the food items from the food item list to the storage chamber UI using a drag and drop method so as to display food storage states of the storage chambers on the storage chamber UI.

2. The refrigerator according to claim 1, further comprising:
an information display area to display information of the stored foods; and
the food item list to display a list of the stored foods.

3. The refrigerator according to claim 1, wherein the storage chamber UI is divided into a freezing chamber door area, a freezing chamber shelf area, a refrigerating chamber shelf area and a refrigerating chamber door area.

4. The refrigerator according to claim 3, wherein each of the freezing chamber door area, the freezing chamber shelf area, the refrigerating chamber shelf area and the refrigerating chamber door area is divided into an upper sub-area and a lower sub-area.

5. The refrigerator according to claim 2, wherein the food item list includes a page information display area to display the greater number of food items than the number of current displayed food items.

6. The refrigerator according to claim 2, further comprising an adding button to add food items to the storage chamber UI,
wherein, when a food item displayed in the food item list is added through the adding button, the food item is moved using the drag and drop method.

7. The refrigerator according to claim 2, further comprising a trash bin icon to delete food items in the storage chamber UI,
wherein, when a food item displayed in the storage chamber UI is deleted, the food item is moved to the trash bin icon using the drag and drop method.

8. The refrigerator according to claim 2, wherein the food item list displays food items corresponding to the foods stored in the storage chambers by applying priority to foods having shorter remaining best before periods from among the foods stored in the storage chambers.

9. The refrigerator according to claim 8, wherein the food item list displays the food items in order of food items corresponding to foods, best before periods of which have expired, food items corresponding to foods, best before periods of which expires within a designated period, and food items corresponding to foods, best before periods of which remain for more than the designated period.

10. The refrigerator according to claim 2, wherein the food item list displays food items corresponding to foods, best before periods of which have expired, and food items corresponding to foods, best before periods of which expire within a designated period, from among the foods stored in the storage chambers.

11. The refrigerator according to claim 1, wherein icons of the food items are formed in shapes of corresponding foods so that actual foods may be judged through the icons.

12. The refrigerator according to claim 11, wherein the icons of the food items are provided with names of corresponding foods.

13. The refrigerator according to claim 2, wherein, when a food item located in the storage chamber UI is selected, storage information of corresponding food is displayed in the information display area.

14. The refrigerator according to claim 13, wherein the information of the corresponding food includes at least one of a stored date, a recommended best before period and days past the recommended best before period.

15. A refrigerator comprising:
storage chambers to store foods; and
a touch screen-type display unit to display food items corresponding to the foods stored in the storage chambers in shapes of icons and to add, delete and move the icons of the food items using a drag and drop method so as to display food storage states of the storage chambers.

16. The refrigerator according to claim 15, further comprising:
a storage chamber user interface (UI) to represent the internal structures of the storage chambers and to display kinds and storage locations of the foods stored in the storage chambers through shapes and locations of the icons of the food items;
an information display area to display information regarding the foods; and
a food item list to display a list of the foods

17. The refrigerator according to claim 15, wherein the storage chamber UI is divided into a freezing chamber door area, a freezing chamber shelf area, a refrigerating chamber shelf area and a refrigerating chamber door area.

18. The refrigerator according to claim 17, wherein each of the freezing chamber door area, the freezing chamber shelf area, the refrigerating chamber shelf area and the refrigerating chamber door area is divided into an upper sub-area and a lower sub-area.

19. A refrigerator comprising:
storage chambers to store foods; and
a display unit to display a storage chamber user interface (UI) representing the internal structures of the storage chambers, an information display area to display information of the stored foods and a food item list to display food items, and to move the food items from the food item list to the storage chamber UI using a drag and drop method so as to display food storage states of the storage chambers on the storage chamber UI.

20. The refrigerator according to claim 20, wherein the food item list includes a list of food items where a best before period has expired, a list of food items where a the best before period is currently expiring, a list of food items where the best before period is within a predetermined number of days, and a list of food items where the best before period is outside the predetermined number of days.
